(19) United States
(12) Patent Application Publication
(10) Pub. No.: US 2015/0351065 A1
(43) Pub. Date: Dec. 3, 2015

(54) LOCATION CONTROLLED IMS REGISTRATION

(71) Applicant: NOKIA SOLUTIONS AND NETWORKS OY, Espoo (FI)

(72) Inventors: Martin OETTL, Weilheim (DE); Peter LEIS, Penzberg (DE)

(21) Appl. No.: 14/759,567

(22) PCT Filed: Jan. 18, 2013
(86) PCT No.: PCT/EP2013/050876

§ 371 Date: Jul. 7, 2015

(51) Int. Cl. H04W 60/00; H04W 12/06; H04W 48/16

(52) U.S. Cl. CPC H04W 60/00; H04W 48/16; H04W 12/06

(57) ABSTRACT

An apparatus of a communication network system acquires (S12) location information regarding a current location of a user equipment for a register request of the user equipment requesting registration with a multimedia subsystem of the communication network system, via a home network of the user equipment in the communication network system, and continues (S14) with the requested registration with the multimedia subsystem or denies (S15) the requested registration based on a check (S13) whether or not the current location acquired via the home network is an allowed location.

### BACKGROUND OF THE INVENTION

1. Field of the Invention

The present invention relates to location controlled IMS registration.

2. Related Background Art

The following meanings for the abbreviations used in this specification apply:

### 3GPP Third Generation Partnership Project

### AAA Authentication Authorization and Accounting

### BBF BroadBand Forum

CLF Connectivity session Location and repository Function

### CN Core Network

### CSCF Call Session Control Function

### DSLAM Digital Subscriber Line Access Multiplexer

### HSS Home Subscriber Server

### EPC Enhanced Packet Core

### I-CSCF Interrogating CSCF

### IMS IP Multimedia Core Network Subsystem

### IP Internet Protocol

### MAR Multimedia Authentication Request

### MME Mobility Management Entity

### NASS Network Access Subsystem

### P-CSCF Proxy-CSCF

### SAA Server Assignment Answer

### SAR Server Assignment Request

### S-CSCF Serving-CSCF

### SIP Session Initiation Protocol

### UE User Equipment

### UPSF User Profile Server Function

According to a recent 3GPP standardization approach, control of IMS registration should be based on network provided location information of a UE requesting the IMS registration, such as IP address, DSLAM information, etc. The registration control should be based on subscription information which indicates whether registration control applies and to which location registrations are to be restricted.

FIG. 6 shows a signaling diagram illustrating an NASS-IMS-bundled authentication according to the prior art. With the NASS-IMS-bundled authentication it is possible for a UE to gain access to IMS based on successful access level authentication. This is achieved by associating an IMS identity with a fixed specific location, e.g. a line id, from where access to a communication network system is authorized.

As a part of this solution, a P-CSCF retrieves location information from an access network and delivers this location information to an I-CSCF and S-CSCF. FIG. 6 gives an overview of the solution.

In step 1 of FIG. 6, after an NASS authentication and network attachment between the UE and the access network, the UE sends a register request for registering with the IMS to the P-CSCF. In the procedure steps 2 and 3 of FIG. 6, the P-CSCF queries via an e2 interface a CLF function in order to get the location information, i.e. the fixed line id.

In steps 4 and 7 of FIG. 6, the location information is further sent to the S-CSCF which then queries an UPSF, e.g. an HSS, in steps 8 and 9 in order to compare the line id with user profile information regarding the UE (block “Compare Line-Identifier(s)” FIG. 6).

If the line id stored in the HSS and the one received from the P-CSCF/CLF are identical the UE is allowed to register in IMS.

In the above-described NASS-IMS bundled mechanism, the e2 interface is used for retrieving the location information. Further, the above-described NASS-IMS bundled approach does not support roaming.

### SUMMARY OF THE INVENTION

The present invention aims at overcoming the above problems and at providing a broader concept for retrieving location information required for IMS registration.

This is, at least in part, achieved by the methods and apparatuses defined in the appended claims. The invention may also be implemented by a computer program product.

The concept for retrieving location information according to the present invention avoids the use of the e2 interface, and at least one embodiment of the invention supports roaming and cellular access. A generic solution of IMS registration control based on location is provided, which is also applicable in cellular environments.

In the following the invention will be described by way of embodiments thereof with reference to the accompanying drawings.

### BRIEF DESCRIPTION OF THE DRAWINGS

FIG. 1 shows a flow chart illustrating a first process for location controlled IMS registration according to an embodiment of the invention.

FIG. 2 shows a flow chart illustrating a second process for location controlled IMS registration according to an embodiment of the invention.

FIG. 3 shows a signaling diagram illustrating location retrieval during IMS registration for a fixed line UE according to an implementation example of the invention.

FIG. 4 shows a signaling diagram illustrating location retrieval during IMS registration for a cellular UE according to an implementation example of the invention.

FIG. 5 shows a schematic block diagram illustrating a configuration of control units in which examples of embodiments of the invention are implementable.

FIG. 6 shows a signaling diagram illustrating an NASS-IMS-bundled authentication according to the prior art.

### DESCRIPTION OF THE EMBODIMENTS

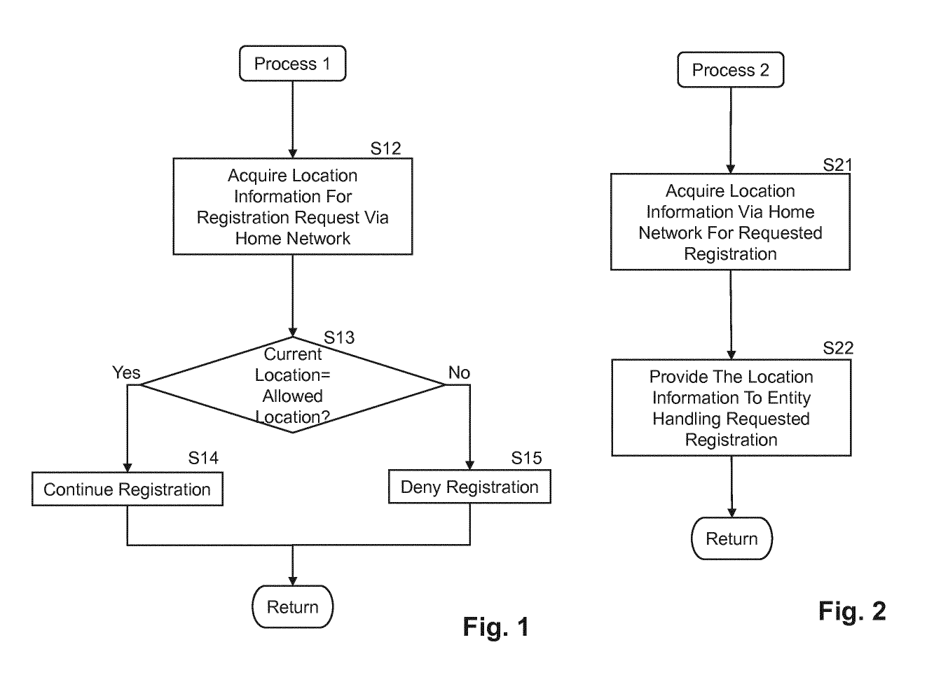

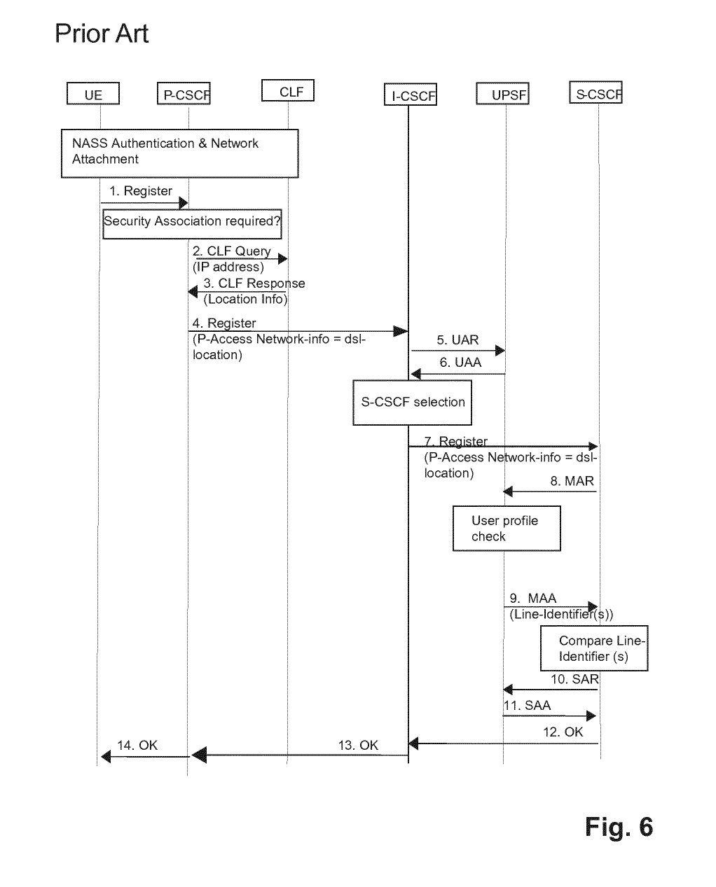

In the following embodiments of the invention will be described. FIGS. 1 and 2 show processes for location controlled IMS registration according to an embodiment of the invention, in which location information (e.g. line id) retrieval via P-CSCF/CLF as shown in the prior art solution of FIG. 6 is avoided.

According to at least one embodiment of the invention, location controlled IMS registration is performed by retrieval of the location information (e.g. the line id for a fixed access) in a home network of a UE requesting the registration. In other words, a home network IMS is allowed to retrieve the location information on reception of a register request, e.g. an SIP REGISTER request.

Now reference is made to the flowchart of FIG. 1 illustrating a process 1 which may be executed by an apparatus of a communication network system. According to an implementation example, the apparatus comprises an S-CSCF.

In step S12, for a register request of a user equipment (UE) requesting registration with a multimedia subsystem (IMS) of the communication network system location information regarding a current location of the user equipment is acquired via a home network of the user equipment in the communication network system. In step S13, based on the location information acquired via the home network, it is checked whether to continue with the registration with the multimedia subsystem or deny the registration request. For example, in case the current location of the user equipment belongs to allowed locations for registration with the multimedia subsystem (yes in step S13), the registration procedure is continued (step S14). Otherwise (no in step S13), the registration request is denied (step S15).

According to an embodiment, the location information is requested from a database entity in the home network, the database entity storing user profile information of the user equipment, the user profile information comprising the allowed locations for registration with the multimedia subsystem. For example, the database entity comprises an HSS.

Alternatively or in addition, the allowed locations and the current location of the user equipment are requested from the database. As mentioned above, the requested registration is continued in case the current location belongs to the allowed locations, and denied otherwise.

According to an implementation example of the invention described later on, the location information/allowed locations and current location is/are requested over a Cx interface. The location information/allowed locations and current location is/are may also be requested using a multimedia authentication request.

Now reference is made to the flowchart of FIG. 2 illustrating a process 2 which may be executed by an apparatus of the home network of a user equipment of the communication network system, i.e. the above-mentioned database entity. According to an implementation example of the invention, the database entity comprises an HSS.

In step S21 of process 2, for the above-mentioned register request of the user equipment, the location information regarding the current location of the user equipment is acquired. In step S22, the location information is provided to an entity of the communication network system handling the requested registration for continuing with the requested registration with the multimedia subsystem or denying the registration based on the location information. The entity may be the above apparatus suitable for executing process 1.

According to an embodiment of the invention, the allowed locations and the current location of the user equipment may be provided to the entity as the location information. Alternatively or in addition, it may be checked whether or not the current location belongs to the allowed locations, and a response to continue with the requested registration may be provided to the entity as the location information in case the current location belongs to the allowed locations, and a response to deny the requested registration may be provided to the entity as the location information otherwise.

According to an embodiment, a type of access of the user equipment to the communication network system is detected, and in case a fixed line access is detected, information about the current location is requested from an authentication server (e.g. AAA) authenticating the user equipment when the fixed line access is established.
In case a cellular access is detected, information about the current location is requested from an entity (e.g. MME) managing mobility of the user equipment in the communication network system.

According to an implementation example of the invention, the information about the current location is requested from the authentication server over an SWx interface, or the current location is requested from the entity managing mobility of the user equipment over an S6a interface.

As described above, the line id retrieval via P-CSCF/CLF according to the prior art shown in FIG. 6 is replaced by retrieval of the location information in the home network, e.g. via the HSS using the appropriate interface. For example, this solution is applicable where an access network of the UE is connected to an EPC as specified by 3GPP.

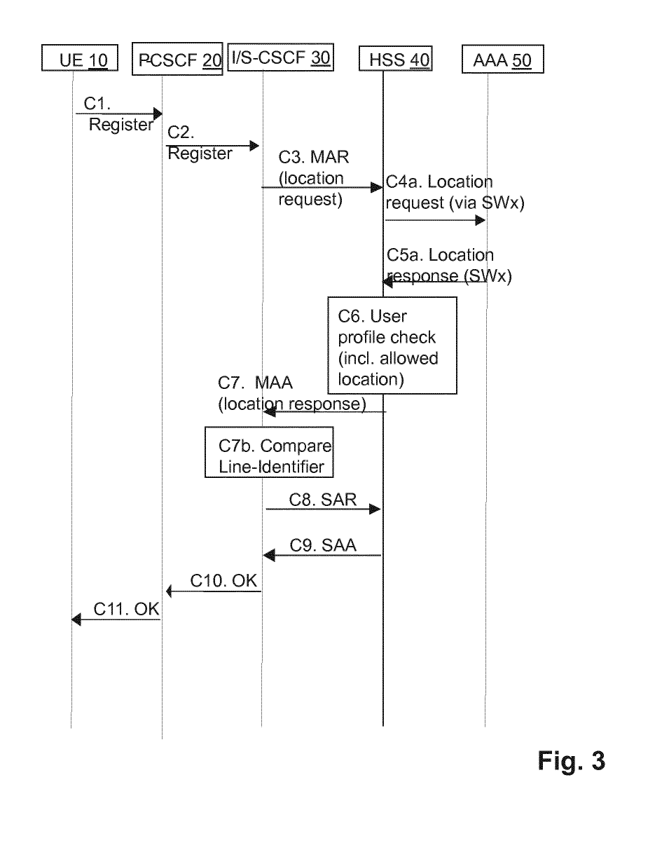

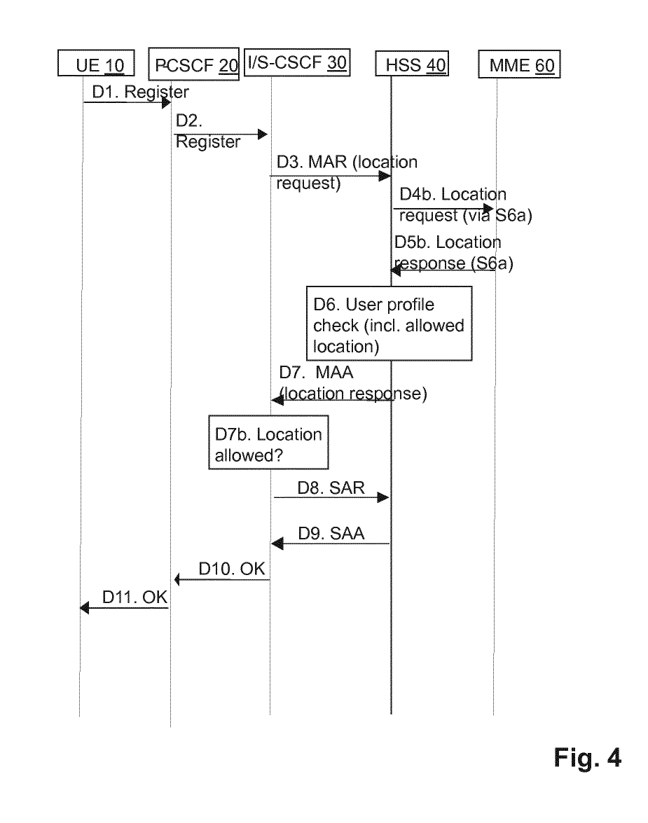

In the following implementation examples of the invention will be described with reference to FIGS. 3 and 4.

FIGS. 3 and 4 show signaling diagrams illustrating signaling between a UE 10, a P-CSCF 20, an I/S-CSCF 30, an HSS 40 and an AAA server 50/MME 60. The I/S-CSCF 30 may execute above-described process 1 schematically shown in FIG. 1, and the HSS 40 may execute above-described process 2 schematically shown in FIG. 2.

Referring to FIG. 3, in step C1 the UE 10 sends a new SIP REGISTER message to the P-CSCF 20.

In step C2, the P-CSCF forwards the SIP REGISTER message to the I-CSCF.

In step C3, the I-CSCF contacts the HSS 40 to find the proper S-CSCF 30 and sends the SIP REGISTER message to the S-CSCF 30 chosen to serve the UE 10. The S-CSCF 30 queries the HSS 40 over a Cx interface as part of the IMS registration procedure, using an MAR procedure. In other words, the S-CSCF 30 queries the HSS 40 for acquiring location information regarding the current location of the UE 10 requesting registration with the IMS.

Depending on the type of access used by the UE 10 (fixed or cellular), different interfaces/procedures are used by the HSS 40 for acquiring the location information. The HSS may recognize the type of access based on information stored in the HSS or dependant on signaling information. This is out of scope of the present invention.

In case of a fixed line UE 10 illustrated in FIG. 3, where the access network providing access for the UE 10 to the EPC is using a BBF Interworking architecture, in step C4a the HSS 40 queries the AAA server 50 for the location information via an interface SWx.

In step C5a, the AAA server 50 provides the location information back to the HSS 40. The location information contains an IP address, but may also contain more granular information.

In step C6, the HSS 40 checks user profile information including a stored list of allowed locations, which is stored in the HSS 40, against the current location retrieved from the AAA server 50.

In step C7, in case the current location is not allowed to be used for IMS registration, the HSS 40 sends a negative response back to the S-SCSF 30. Otherwise, if the current location is allowed the HSS 40 continues with the normal IMS registration procedure and sends a positive response back to the S-CSCF 30. In other words, the HSS 40 provides a response to deny the requested registration as the location information (negative response) to the S-CSCF in case the current location does not belongs to the allowed locations, and provides a response to continue with the requested registration as the location information (positive response) to the S-CSCF 30 otherwise.

Alternatively, as shown in step C7b, the location check of step C6 may be done in the S-SCSF 30. In that case, the HSS 40 provides in step C7 the list of allowed locations in conjunction with the current location as the location information to the S-CSCF 30, and the S-CSCF 30 performs the location check.

In steps C8-C11, the S-CSCF 30 continues with the registration procedure as guided by the HSS 40, i.e., either rejects or accepts the registration request.

FIG. 4 shows location controlled IMS registration for a case of a cellular UE 10. Since steps D1-D3 and D6-D11 correspond to steps C1-C3 and C6-C11 described with reference to FIG. 3, these steps will not be described again.

In case of a cellular UE 10, i.e. when the HSS 40 detects that the UE 10 has a cellular access to the EPC, in step D4b, the HSS 40 queries the MME 60 for the location information via an S6a interface. In step D5b the MME 60 provides the location information back to the HSS 40. As mentioned above, steps D6-D11 are the same as for the fixed line access.

The above-described approach according to at least one embodiment or implementation example of the invention supports roaming and cellular access of a user equipment requesting registration with IMS.

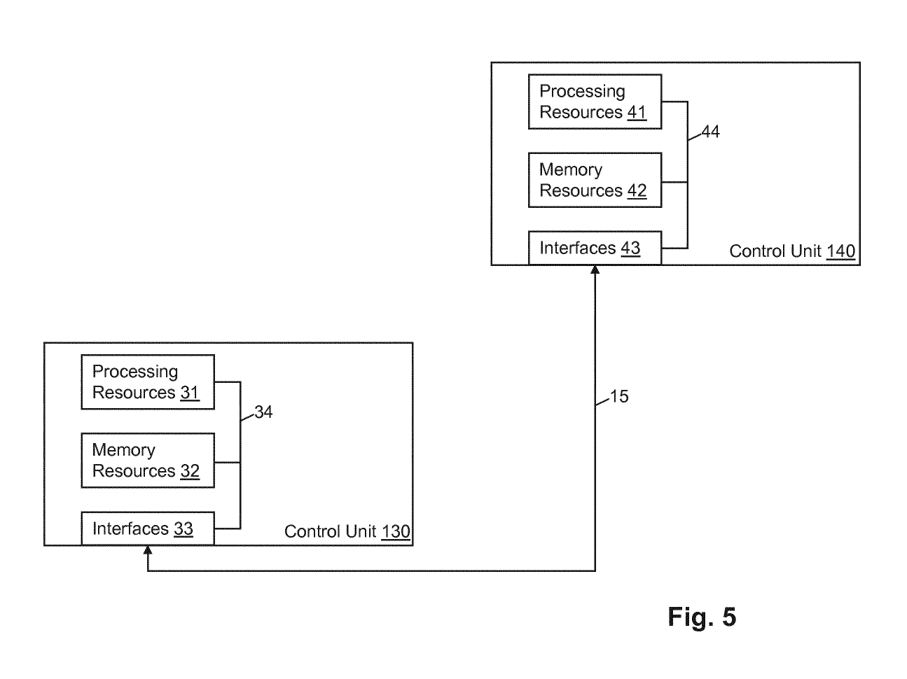

Now reference is made to FIG. 5 for illustrating simplified block diagrams of various electronic devices that are suitable for use in practicing the embodiments and implementation example of this invention.

A control unit 130 comprises processing resources 31, memory resources 32 and interfaces 33 which are coupled via a link 34. The memory resources 32 may store a program. The control unit 130 may execute process 1 described in connection with FIG. 1, and may be part of or used by the S-CSCF 30 of FIGS. 3 and 4.

A control unit 140 comprises processing resources 41, memory resources 42 and interfaces 43 which are coupled via a link 44. The memory resources 42 may store a program. The control unit 140 may execute process 2 described in connection with FIG. 2, and may be part of or used by the HSS 40 of FIGS. 3 and 4.

The control unit 130 and the control unit 140 may be connected via their interfaces 33 and 43 over a link 15.

The terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and printed electrical connections, as well as by the use of electromagnetic energy, such as electromagnetic energy having wavelengths in the radio frequency region, the microwave region and the optical (both visible and invisible) region, as non-limiting examples.

At least one of the programs stored in the memory resources 32, 42 is assumed to include program instructions that, when executed by the associated processing resources 31, 41, enable the electronic device to operate in accordance with the embodiments and implementation examples of this invention, as detailed above.

In general, the embodiments and implementation examples of this invention may be implemented by computer software stored in the memory resources 32, 42 and executable by the processing resources 31, 41, or by hardware, or by a combination of software and/or firmware and hardware in any or all of the devices shown.

The memory resources 32, 42 may be of any type suitable to the local technical environment and may be implemented using any suitable data storage technology, such as semiconductor-based memory devices, magnetic memory devices and systems, optical memory devices and systems, fixed memory and removable memory. The processing resources 31, 41 may be of any type suitable to the local technical environment, and may include one or more of general purpose computers, special purpose computers, microprocessors, digital signal processors (DSPs) and processors based on a multi-core processor architecture, as non-limiting examples.

According to an aspect of the invention, an apparatus of a communication network system, such as an S-CSCF, which may use and/or comprise the control unit 30 comprising the processing resources 31, memory resources 32 and interfaces 33, comprises means for acquiring location information regarding a current location of a user equipment for a register request of the user equipment requesting registration with a multimedia subsystem of the communication network system via a home network of the user equipment in the communication network system, and means for continuing with the requested registration with the multimedia subsystem or denying the requested registration based on the location information acquired via the home network.

The means for location information acquiring may comprise means for requesting the location information from a database entity in the home network, the database entity storing user profile information of the user equipment, the user profile information comprising allowed locations for registration with the multimedia subsystem.

Alternatively or in addition, the means for location information acquiring may comprise means for requesting allowed locations from a database entity in the home network, the database entity storing user profile information of the user equipment, the user profile information comprising the allowed locations for registration with the multimedia subsystem, and requesting the current location of the user equipment from the database entity, wherein the means for continuing or denying continues with the requested registration in case the current location belongs to the allowed locations, and denies the requested registration otherwise.

The means for requesting may request the location information/allowed locations and current location over a Cx interface. The means for requesting may request the location information/allowed locations and current location using a multimedia authentication request.

The means for acquiring, continuing or denying and requesting may be implemented using the processing resources 31, memory resources 32 and interfaces 33.

According to a further aspect of the invention, an apparatus of a home network of a user equipment in a communication network system, such as an HSS, which may use and/or comprise the control unit 40 comprising the processing resources 41, memory resources 42 and interfaces 43, comprises a database storing user profile information of the user equipment, the user profile information comprising allowed locations for registration with a multimedia subsystem. The memory resources 42 may comprise the database. The apparatus further comprises means for acquiring location information regarding a current location of the user equipment requesting registration with the multimedia subsystem of the communication network system, and means for providing the location information to an entity of the communication network system handling the requested registration for continuing with the requested registration with the multimedia subsystem or denying the registration based on the location information.

The means for location information providing may provide the allowed locations and the current location of the user equipment as the location information to the entity of the communication network system handling the requested registration.

Alternatively or in addition, the means for location information providing may comprise means for checking whether or not the current location belongs to the allowed locations, and may provide a response to continue with the requested registration as the location information to the entity of the communication network system handling the requested registration in case the current location belongs to the allowed locations, and provide a response to deny the requested registration as the location information to the entity otherwise.

The means for location information acquiring may comprise means for detecting a type of access of the user equipment to the communication network system, and means for, in case a fixed line access is detected, requesting information about the current location from an authentication server authenticating the user equipment when the fixed line access is established, and in case a cellular access is detected, requesting information about the current location from an entity managing mobility of the user equipment in the communication network system.

The means for requesting may request the information about the current location from the authentication server over an SWx interface, and/or from the entity managing mobility of the user equipment over an S6a interface.

The means for acquiring, providing, checking, detecting and requesting may be implemented by the processing resources 41, memory resources 42 and interfaces 43.

It is to be understood that the above description is illustrative of the invention and is not to be construed as limiting the invention. Various modifications and applications may occur to those skilled in the art without departing from the true spirit and scope of the invention as defined by the appended claims.

1. A method for use by an apparatus of a communication network system, the method comprising:
acquiring location information regarding a current location of a user equipment for a register request of the user equipment requesting registration with a multimedia subsystem of the communication network system via a home network of the user equipment in the communication network system; and
continuing with the requested registration with the multimedia subsystem or denying the requested registration based on the location information acquired via the home network.

2. The method of claim 1, the location information acquiring comprising:
requesting the location information from a database entity in the home network, the database entity storing user profile information of the user equipment, the user profile information comprising allowed locations for registration with the multimedia subsystem.

3. The method of claim 1, the location information acquiring comprising:
requesting allowed locations from a database entity in the home network, the database entity storing user profile information of the user equipment, the user profile information comprising the allowed locations for registration with the multimedia subsystem, and requesting the current location of the user equipment from the database entity; and
continuing with the requested registration in case the current location belongs to the allowed locations, and denying the requested registration otherwise.

4. The method of claim 2, wherein
the location information/allowed locations and current location is/are requested over a Cx interface, or
the location information/allowed locations and current location is/are requested using a multimedia authentication request.

5. A method for use by an apparatus of a home network of a user equipment in a communication network system, the apparatus comprising a database storing user profile information of the user equipment, the user profile information comprising allowed locations for registration with a multimedia subsystem, the method comprising:
acquiring location information regarding a current location of the user equipment requesting registration with the multimedia subsystem of the communication network system; and
providing the location information to an entity of the communication network system handling the requested registration for continuing with the requested registration with the multimedia subsystem or denying the registration based on the location information.

6. The method of claim 5, the location information providing comprising:
providing the allowed locations and the current location of the user equipment as the location information to the entity of the communication network system handling the requested registration.

7. The method of claim 5, the location information providing comprising:
checking whether or not the current location belongs to the allowed locations; and
providing a response to continue with the requested registration as the location information to the entity of the communication network system handling the requested registration in case the current location belongs to the allowed locations, and providing a response to deny the requested registration as the location information to the entity otherwise.

8. The method of claim 5, the location information acquiring comprising:
detecting a type of access of the user equipment to the communication network system; and
in case a fixed line access is detected, requesting information about the current location from an authentication server authenticating the user equipment when the fixed line access is established, and
in case a cellular access is detected, requesting information about the current location from an entity managing mobility of the user equipment in the communication network system.

9. The method of claim 8, wherein the information about the current location is requested from the authentication server over an SWx interface, or the current location is requested from the entity managing mobility of the user equipment over an S6a interface.

10. A computer program product embodied on a non-transitory computer-readable medium, said product including a program for a processing device, comprising software code portions for performing the steps of claim 1 when the program is run on the processing device.

11. (canceled)

12. The computer program product according to claim 10,
wherein the program is directly loaded into an internal memory of the processing device.

13. An apparatus of a communication network system, the apparatus comprising processing resources, memory resources and interfaces, which cause the apparatus to perform:
acquiring location information regarding a current location of a user equipment for a register request of the user equipment requesting registration with a multimedia subsystem of the communication network system via a home network of the user equipment in the communication network system; and
continuing with the requested registration with the multimedia subsystem or denying the requested registration based on the location information acquired via the home network.

14. The apparatus of claim 13, the location information acquiring comprising:
requesting the location information from a database entity in the home network, the database entity storing user profile information of the user equipment, the user profile information comprising allowed locations for registration with the multimedia subsystem.

15. The apparatus of claim 13, the location information acquiring comprising:
requesting allowed locations from a database entity in the home network, the database entity storing user profile information of the user equipment, the user profile information comprising the allowed locations for registration with the multimedia subsystem, and requesting the current location of the user equipment from the database entity; and
continuing with the requested registration in case the current location belongs to the allowed locations, and denying the requested registration otherwise.

16. The apparatus of claim 14 or 15, wherein
the location information/allowed locations and current location is/are requested over a Cx interface, or
the location information/allowed locations and current location is/are requested using a multimedia authentication request.

17. An apparatus of a home network of a user equipment in a communication network system, the apparatus comprising processing resources, memory resources and interfaces, and having a database storing user profile information of the user equipment, the user profile information comprising allowed locations for registration with a multimedia subsystem, the processing resources, memory resources and interfaces causing the apparatus to perform:
acquiring location information regarding a current location of the user equipment requesting registration with the multimedia subsystem of the communication network system; and
providing the location information to an entity of the communication network system handling the requested registration for continuing with the requested registration with the multimedia subsystem or denying the registration based on the location information.

18. The apparatus of claim 17, the location information providing comprising:
providing the allowed locations and the current location of the user equipment as the location information to the entity of the communication network system handling the requested registration.

19. The apparatus of claim 17, the location information providing comprising:
checking whether or not the current location belongs to the allowed locations; and
providing a response to continue with the requested registration as the location information to the entity of the communication network system handling the requested registration in case the current location belongs to the allowed locations, and providing a response to deny the requested registration as the location information to the entity otherwise.

20. The apparatus of claim 17, the location information acquiring comprising:
detecting a type of access of the user equipment to the communication network system; and
in case a fixed line access is detected, requesting information about the current location from an authentication server authenticating the user equipment when the fixed line access is established, and
in case a cellular access is detected, requesting information about the current location from an entity managing mobility of the user equipment in the communication network system.

21. The apparatus of claim 20, wherein the information about the current location is requested from the authentication server over an SWx interface, or the current location is requested from the entity managing mobility of the user equipment over an S6a interface.
